(19) United States
(12) Patent Application Publication
(10) Pub. No.: US 2026/0011516 A1
(43) Pub. Date: Jan. 8, 2026

(54) SMALL-SIZE HIGH-VOLTAGE DIRECT CURRENT CONTACTOR

(71) Applicant: KUNSHAN GUOLIYUANTONG NEW ENERGY TECHNOLOGY CO., LTD., Suzhou, Jiangsu (CN)

(72) Inventors: EnYao QIN, Suzhou, Jiangsu (CN); ChunPeng GU, Suzhou, Jiangsu (CN); Kang LI, Suzhou, Jiangsu (CN)

(21) Appl. No.: 19/117,231

(22) PCT Filed: Dec. 7, 2022
(86) PCT No.: PCT/CN2022/137111

§ 371 Date: Mar. 31, 2025

(30) Foreign Application Priority Data
Nov. 4, 2022 (CN) 202211380070.5

(51) Int. Cl. H01H 50/04; H01H 50/42; H01H 50/54; H01H 50/58

(52) U.S. Cl. CPC H01H 50/045; H01H 50/42; H01H 50/541; H01H 50/58

(57) ABSTRACT

Disclosed in the present disclosure is a small-size HV DC contactor, comprising a main contact assembly, an auxiliary contact assembly and a shaft assy. The upper end of the shaft assy is respectively connected to the main contact assembly and the auxiliary contact assembly to drive and control the main contact assembly and the auxiliary contact assembly to perform working state switching, respectively; a mounting frame is provided to cover outside the upper end of the shaft assy; a first mounting structure used for bearing and limiting the auxiliary contact assembly is arranged on the side vertical wall of the mounting frame; and the auxiliary contact assembly can be formed into a normally-closed auxiliary contact assembly by means of the combination of the first mounting structure and the shaft assy.

### TECHNICAL FIELD

The present disclosure relates to the technical field of direct current contactors (DC contactor), and particularly to a small-size high-voltage direct current contactor (HV DC contactor).

### BACKGROUND ART

An HV DC contactor structure is usually provided with two contacts, one being a main contact assembly that is used for switching main circuit through a low-voltage driving part, and the other being an auxiliary contact assembly that is used as a monitor switch for control functions of a circuit.

With regard to the auxiliary contact assembly, a structure as shown in Chinese patent CN110164737A is mostly adopted in the industry at present. However, the auxiliary contact assembly of this structure has following shortcomings: 1) an HV DC contactor product with an auxiliary contact has a larger size than an HV DC contactor product without the auxiliary contact, thus limiting application of the HV DC contactor; 2) there are technical problems such as complex parts, complex process, high cost, and low reliability, and 3) only one type of auxiliary contact assembly form can be formed, such as: either a normally-open auxiliary contact assembly or a normally-closed auxiliary contact assembly, thus having poor universality; etc.

In view of this, the present disclosure is specifically proposed.

### SUMMARY

In order to overcome the above defects, the present disclosure provides a small-size HV DC contactor. On the one hand, it has a novel and reasonable structure, a small size, controllability, and high universality and applicability, and can meet use requirements for HV DC contactors in different operation scenarios; and on the other hand, it is easy to process and install, thus improving assembly efficiency and assembly precision.

In order to solve the technical problems, the present disclosure adopts technical solutions as follows. A small-size HV DC contactor is provided, including a main contact assembly, an auxiliary contact assembly and a shaft assy, where an upper end portion of the shaft assy is connected to the main contact assembly and the auxiliary contact assembly, respectively, so as to drive and control the main contact assembly and the auxiliary contact assembly to perform operation state switching, respectively. An installation frame is provided, where the installation frame covers the outside of the upper end portion of the shaft assy, the installation frame is provided with, on a side vertical wall, a first installation structure configured to carry and limit the auxiliary contact assembly, and through a combination of the first installation structure and the shaft assy, the auxiliary contact assembly can be formed into a normally-closed auxiliary contact assembly.

As further improvement of the present disclosure, the installation frame is in an inverted U shape, and is fixedly covered on the outside of the upper end portion of the shaft assy, and the installation frame is provided with the first installation structure on at least one of two side vertical walls.

As further improvement of the present disclosure, the installation frame is provided with, respectively on the two side vertical walls, the first installation structure; and the auxiliary contact assembly can be selectively provided on any one of the two first installation structures.

As further improvement of the present disclosure, the auxiliary contact assembly includes an auxiliary stationary contact and an auxiliary movable contact piece which are vertically provided, where the auxiliary movable contact piece is connected to the upper end portion of the shaft assy;
each of the first installation structures is provided with a first stationary installation portion provided on an outer surface of the side vertical wall of the installation frame, and a first movable installation portion provided on the side vertical wall of the installation frame and meanwhile located below the first stationary installation portion, where the first stationary installation portion is configured to install the auxiliary stationary contact, and the first movable installation portion is configured for the auxiliary movable contact piece to extend out of the installation frame; and
when the auxiliary contact assembly is provided on one of the first installation structures, a part of the auxiliary movable contact piece extending out of the installation frame is disposed below the auxiliary stationary contact, and the first movable installation portion can further abut against the auxiliary movable contact piece, and form a rotational fulcrum at an abutting place.

As further improvement of the present disclosure, when the auxiliary contact assembly is provided on one of the first installation structures, the auxiliary movable contact piece can be driven by the shaft assy to partially move upwards, and partially deflect downwards around the rotational fulcrum, so that the part of the auxiliary movable contact piece extending out of the installation frame is disconnected from the auxiliary stationary contact; or the auxiliary movable contact piece can be driven by the shaft assy to partially move downwards, and partially deflect upwards around the rotational fulcrum to be reset, so that the part of the auxiliary movable contact piece extending out of the installation frame contacts and communicates with the auxiliary stationary contact; and in this case, the auxiliary contact assembly is formed into the normally-closed auxiliary contact assembly.

As further improvement of the present disclosure, the installation frame is concavely provided with, respectively on outer surfaces of the two side vertical walls, a first receiving slot extending in a vertical direction, where the two first receiving slots are both the first stationary installation portions, and are both configured to insert the auxiliary stationary contact.

As further improvement of the present disclosure, the auxiliary stationary contact includes a main body portion in a cylindrical-rod shape, a head portion provided on an upper end of the main body portion, and a stationary contacting portion provided on a bottom end of the main body portion; and
the first receiving slots are elongated arc-shaped slots matching the main body portion in shape.

As further improvement of the present disclosure, the installation frame is formed with, respectively on the two side vertical walls, a first avoidance groove having an opening on a bottom side of the two side vertical walls, where the two first avoidance grooves are respectively correspondingly located below the two first receiving slots, the two first avoidance grooves are both the first movable installation portions, respectively configured for the auxiliary movable contact piece to move therethrough; and a top wall of each of the first avoidance grooves can further abut against the auxiliary movable contact piece, and form a rotational fulcrum at an abutting place.

As further improvement of the present disclosure, the installation frame is formed with, respectively on the two side vertical walls, a first avoidance groove having an opening on a bottom side of the two side vertical walls and a vertical edge side, and the two first avoidance grooves are respectively correspondingly located below the two first receiving slots, the two first avoidance grooves are both the first movable installation portions, respectively configured for the auxiliary movable contact piece to move therethrough; and a top wall of each of the first avoidance grooves can further abut against the auxiliary movable contact piece, and form a rotational fulcrum at an abutting place.

As further improvement of the present disclosure, the auxiliary movable contact piece adopts an elastic sheet structure, and is provided with a connecting portion configured to be connected to the upper end portion of the shaft assy, a movable contacting portion configured to operate in cooperation with the auxiliary stationary contact, and a joining portion joined between the connecting portion and the movable contacting portion, where the movable contacting portion is in a flat-sheet shape, the movable contacting portion moves through the first avoidance groove, and an end of the movable contacting portion close to the joining portion can abut against the top wall of the first avoidance groove, and form the rotational fulcrum at an abutting place.

As further improvement of the present disclosure, a first side vertical wall of the installation frame is provided with one first installation structure, and a second side vertical wall of the installation frame is provided with one second installation structure; and
the auxiliary contact assembly can be selectively provided on the first installation structure or the second installation structure, where when the auxiliary contact assembly is provided on the first installation structure, the auxiliary contact assembly is formed into the normally-closed auxiliary contact assembly; and when the auxiliary contact assembly is provided on the second installation structure, the auxiliary contact assembly is formed into a normally-open auxiliary contact assembly.

As further improvement of the present disclosure, the auxiliary contact assembly includes an auxiliary stationary contact and an auxiliary movable contact piece that are vertically provided, the auxiliary movable contact piece being connected to the upper end portion of the shaft assy;
the first installation structure includes a first stationary installation portion provided on an outer surface of the first side vertical wall of the installation frame, and a first movable installation portion provided on the first side vertical wall of the installation frame and meanwhile located below the first stationary installation portion, where the first stationary installation portion is configured to install the auxiliary stationary contact, and the first movable installation portion is configured for the auxiliary movable contact piece to extend out of the installation frame; and
when the auxiliary contact assembly is provided on the first installation structure, a part of the auxiliary movable contact piece extending out of the installation frame is disposed below the auxiliary stationary contact, and the first movable installation portion can abut against the auxiliary movable contact piece, and form a rotational fulcrum at an abutting place;
the second installation structure includes a second stationary installation portion provided on an outer surface of the second side vertical wall of the installation frame, and a second movable installation portion provided on the second side vertical wall of the installation frame and meanwhile located below the second stationary installation portion, where the second stationary installation portion is configured to install the auxiliary stationary contact, and the second movable installation portion is configured for the auxiliary movable contact piece to extend out of the installation frame; and
when the auxiliary contact assembly is provided on the second installation structure, the part of the auxiliary movable contact piece extending out of the installation frame is disposed below the auxiliary stationary contact, and the second movable installation portion is always not in contact with the auxiliary movable contact piece.

As further improvement of the present disclosure, when the auxiliary contact assembly is provided on the first installation structure, the auxiliary movable contact piece can be driven by the shaft assy to partially move upwards, and partially deflect downwards around the rotational fulcrum, so that the part of the auxiliary movable contact piece extending out of the installation frame is disconnected from the auxiliary stationary contact; or the auxiliary movable contact piece can be driven by the shaft assy to partially move downwards, and partially deflect upwards around the rotational fulcrum to be reset, so that the part of the auxiliary movable contact piece extending out of the installation frame contacts and communicates with the auxiliary stationary contact; and in this case, the auxiliary contact assembly is formed into the normally-closed auxiliary contact assembly; and when the auxiliary contact assembly is provided on the second installation structure, the auxiliary movable contact piece can be driven by the shaft assy to move upwards, so as to contact and communicate with the auxiliary stationary contact, or move downwards so as to be disconnected from the auxiliary stationary contact; and in this case, the auxiliary contact assembly is formed into the normally-open auxiliary contact assembly.

As further improvement of the present disclosure, the installation frame is concavely provided with, on the outer surface of the first side vertical wall, a first receiving slot extending in a vertical direction, where the first receiving slot is the first stationary installation portion, configured to insert the auxiliary stationary contact; and the installation frame is further concavely provided with, on the outer surface of the second side vertical wall, a second receiving slot extending in the vertical direction, where the second receiving slot is the second stationary installation portion, configured to insert the auxiliary stationary contact; and a vertical height of the first receiving slot is greater than that of the second receiving slot.

As further improvement of the present disclosure, the auxiliary stationary contact includes a main body portion in a cylindrical-rod shape, a head portion provided on an upper end of the main body portion, and a stationary contacting portion provided on a bottom end of the main body portion; and the first receiving slot and the second receiving slot are both elongated arc-shaped slots matching the main body portion in shape.

As further improvement of the present disclosure, the installation frame is formed with, on the first side vertical wall, the first avoidance groove having an opening on a bottom side of the first side vertical wall, where the first avoidance groove is located below the first receiving slot, the first avoidance groove is the first movable installation portion, configured for the auxiliary movable contact piece to move therethrough; and when the auxiliary contact assembly is provided on the first installation structure, a top wall of the first avoidance groove can further abut against the auxiliary movable contact piece, and form a rotational fulcrum at an abutting place; and
the installation frame is further formed with, on the second side vertical wall, a second avoidance groove having an opening on a bottom side of the second side vertical wall, where the second avoidance groove is located below the second receiving slot, the second avoidance groove is the second movable installation portion, configured for the auxiliary movable contact piece to move therethrough; and when the auxiliary contact assembly is provided on the second installation structure, the second avoidance groove is always not in contact with the auxiliary movable contact piece; besides, a vertical height of the second avoidance groove is greater than that of the first avoidance groove.

As further improvement of the present disclosure, the installation frame is formed with, on the first side vertical wall, the first avoidance groove having an opening on a bottom side of the first side vertical wall and a vertical edge side, where the first avoidance groove is located below the first receiving slot, the first avoidance groove is the first movable installation portion, configured for the auxiliary movable contact piece to move therethrough; moreover, when the auxiliary contact assembly is provided on the first installation structure, a top wall of the first avoidance groove can further abut against the auxiliary movable contact piece, and form a rotational fulcrum at an abutting place; and
the installation frame is further formed with, on the second side vertical wall, the second avoidance groove having an opening on a bottom side of the second side vertical wall and a vertical edge side, where the second avoidance groove is located below the second receiving slot, the second avoidance groove is the second movable installation portion, configured for the auxiliary movable contact piece to move therethrough; moreover, when the auxiliary contact assembly is provided on the second installation structure, the second avoidance groove is always not in contact with the auxiliary movable contact piece; besides, a vertical height of the second avoidance groove is greater than that of the first avoidance groove.

As further improvement of the present disclosure, the auxiliary movable contact piece adopts an elastic sheet structure, and is provided with a connecting portion configured to be connected to the upper end portion of the shaft assy, a movable contacting portion configured to operate in cooperation with the auxiliary stationary contact, and a joining portion joined between the connecting portion and the movable contacting portion, where the movable contacting portion is in a flat-sheet shape, the movable contacting portion can move through the first avoidance groove or the second avoidance groove; and when the movable contacting portion moves through the first avoidance groove, an end of the movable contacting portion close to the joining portion abuts against a top wall of the first avoidance groove, and forms the rotational fulcrum at an abutting place.

As further improvement of the present disclosure, a bottom side of the installation frame is fixedly connected to an upper side of a pole plate of the HV DC contactor, and an inner wall of the installation frame is not in contact with the upper end portion of the shaft assy.

As further improvement of the present disclosure, the main contact assembly includes a main stationary contact and a main movable contact piece which are vertically provided, where the main movable contact piece is connected to the upper end portion of the shaft assy, and the main movable contact piece can be driven by the shaft assy to move upwards so as to contact and communicate with the main stationary contact, or move downwards so as to be disconnected from the main stationary contact.

As further improvement of the present disclosure, the shaft assy includes a push rod, an insulating block, a limiting bracket and a contact spring, where a lower end of the push rod is connected to a movable iron core of the HV DC contactor, an upper end of the push rod is fixedly provided with the insulating block, the limiting bracket is vertically installed on the insulating block, a lower end of the contact spring is fixedly provided in the insulating block, an upper end of the contact spring abuts against the main movable contact piece, so as to abut the main movable contact piece on an inner top wall of the limiting bracket; in addition, an end of the auxiliary movable contact piece is fixedly embedded in the insulating block.

As further improvement of the present disclosure, a yoke assy is further provided, where the yoke assy includes an upper yoke and a lower yoke, where the upper yoke is fixedly provided on an inner top wall of the installation frame, and the lower yoke is provided between the main movable contact piece and the contact spring.

The present disclosure has beneficial effects as follows. 1) The present disclosure innovatively introduces the installation frame structure, and with the installation frame structure, without increasing an installation space, the installation of the normally-closed auxiliary contact assembly can be well realized, thus realizing optimal control over dimension of HV DC contactor products, and expanding applicable fields and applicable operation scenarios of the HV DC contactor products. 2) In the HV DC contactor structure according to the present disclosure, the auxiliary contact assembly is simple in structure and easy to process, and it is also quite convenient to install, for example, the auxiliary stationary contact is inserted and limited in the receiving slot of the installation frame, and the connecting portion of the auxiliary movable contact piece is fixedly embedded in the insulating block of the shaft assy through the injection molding process, so as to reduce assembly difficulty, improve assembly efficiency and assembly precision, and further improve operation reliability of the HV DC contactor. 3) In the HV DC contactor structure according to the present disclosure, the upper yoke is also installed on the installation frame, and the method of installing the upper yoke, compared with existing structures, can also effectively reduce the dimension of the HV DC contactor, and can further expand the applicable scenarios of the HV DC contactor. 4) The HV DC contactor designed in the present disclosure is also compatible with the normally-closed auxiliary contact assembly form and the normally-open auxiliary contact assembly form, thus well expanding universality and applicability of application of the HV DC contactor, and meeting use requirements for the HV DC contactor in different operation scenarios.

### BRIEF DESCRIPTION OF DRAWINGS

FIG. 1 is a perspective structural schematic view of an HV DC contactor according to Embodiment 1 of the present disclosure when the auxiliary contact assembly is in a communicating state;

FIG. 2 is a front structural schematic view of the HV DC contactor shown in Embodiment 1;

FIG. 3 is a rear structural schematic view of the HV DC contactor shown in Embodiment 1;

FIG. 4 is a side structural schematic view of the HV DC contactor shown in Embodiment 1;

FIG. 5 is a structural schematic view of the HV DC contactor shown in Embodiment 1, with the auxiliary contact assembly being in a first viewing angle;

FIG. 6 is a structural schematic view of the HV DC contactor shown in Embodiment 1, with the auxiliary contact assembly being in a second viewing angle;

FIG. 7 is a perspective structural schematic view of an HV DC contactor in Embodiment 3 of the present disclosure, with the auxiliary contact assembly being in a disconnected state;

FIG. 8 is a front structural schematic view of the HV DC contactor as shown in FIG. 7;

FIG. 9 is rear structural schematic view of the HV DC contactor as shown in FIG. 7;

FIG. 10 is a side structural schematic view of the HV DC contactor as shown in FIG. 7;

FIG. 11 is a perspective structural schematic view of the HV DC contactor in Embodiment 3 of the present disclosure, with the auxiliary contact assembly being in communicating state;

FIG. 12 is a front structural schematic view of the HV DC contactor as shown in FIG. 11;

FIG. 13 is rear structural schematic view of the HV DC contactor as shown in FIG. 11;

FIG. 14 is a side structural schematic view of the HV DC contactor as shown in FIG. 11;

FIG. 15 is a perspective structural schematic view of the HV DC contactor in Embodiment 3 of the present disclosure, with the auxiliary contact assembly being in disconnected state;

FIG. 16 is a rear structural schematic view of the HV DC contactor as shown in FIG. 15;

FIG. 17 is front structural schematic view of the HV DC contactor as shown in FIG. 15;

FIG. 18 is a side structural schematic view of the HV DC contactor as shown in FIG. 15;

FIG. 19 is a perspective structural schematic view of the HV DC contactor in Embodiment 4 of the present disclosure, with the auxiliary contact assembly being in communicating state;

FIG. 20 is front structural schematic view of the HV DC contactor as shown in FIG. 19; and

FIG. 21 is rear structural schematic view of the HV DC contactor as shown in FIG. 19.

In conjunction with the drawings, description is made as follows:

10, main stationary contact; 11, main movable contact piece; 20, auxiliary stationary contact; 200, main body portion; 201, head portion; 202, stationary contacting portion; 21, auxiliary movable contact piece; 210, connecting portion; 211, movable contacting portion; 212, joining portion; 3, installation frame; 30, first receiving slot; 31, first avoidance groove; 32, second receiving slot; 33, second avoidance groove; 4, pole plate; 50, push rod; 51, insulating block; 52, limiting bracket; 53, contact spring; 60, upper yoke; 61, lower yoke.

### DETAILED DESCRIPTION OF EMBODIMENTS

Preferred embodiments of the present disclosure will be described in detail below in conjunction with drawings.

### Embodiment 1

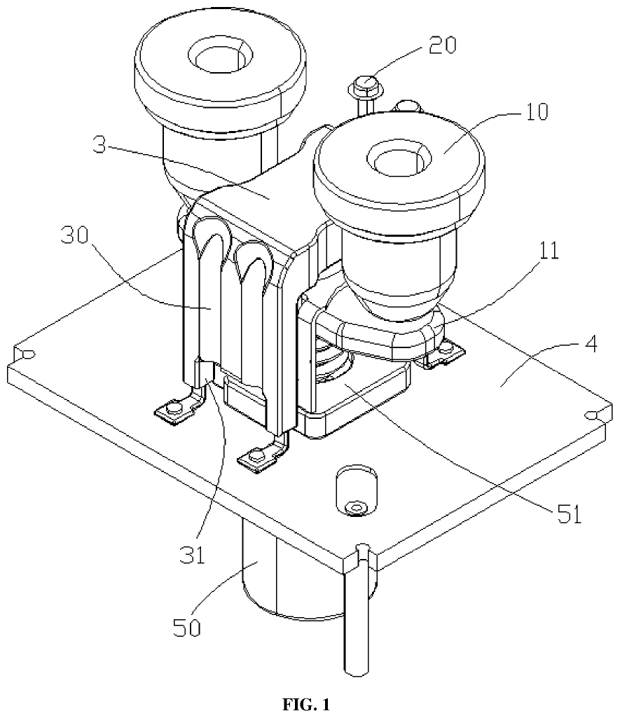

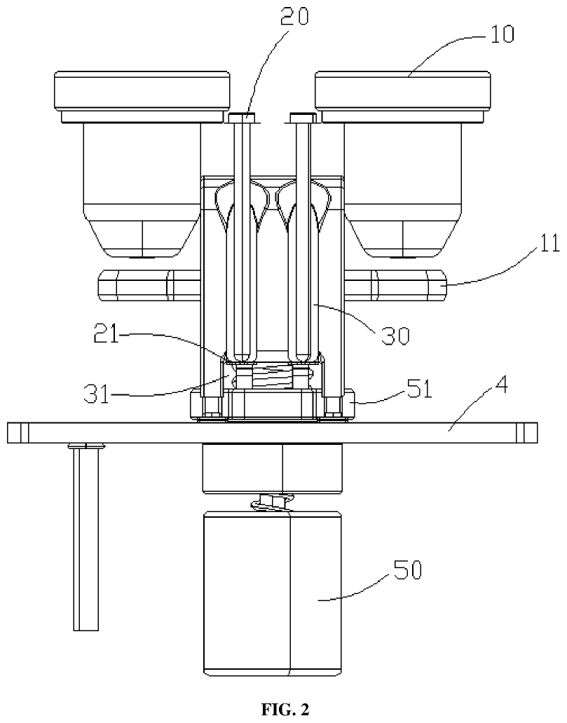

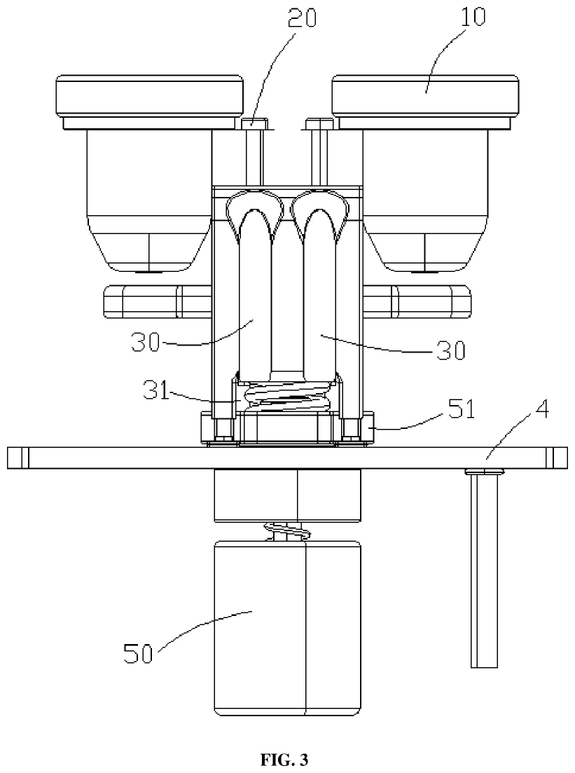

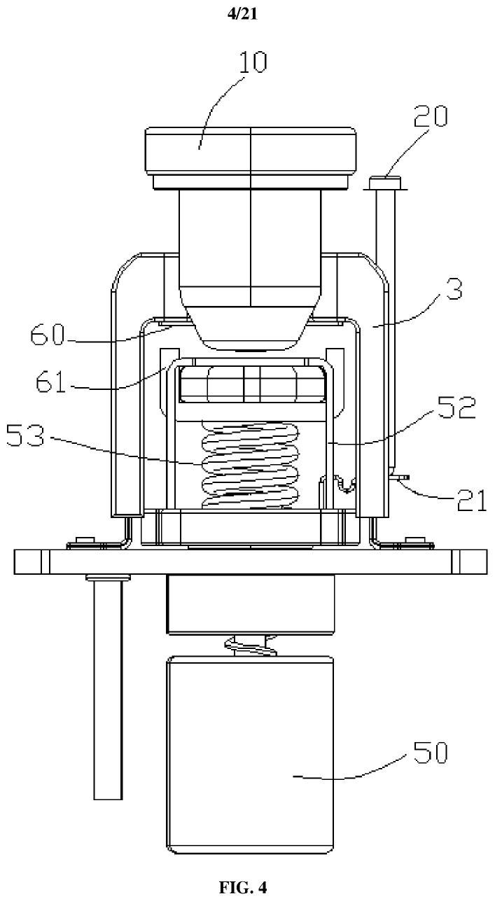

With reference to FIG. 1 to FIG. 4, they are respectively perspective structural schematic view, front structural schematic view, rear structural schematic view and side structural schematic view of an HV DC contactor according to Embodiment 1 when the auxiliary contact assembly is in a communicating state. A small-size HV DC contactor provided in Embodiment 1 mainly includes a main contact assembly, an auxiliary contact assembly and a shaft assy. An upper end portion of the shaft assy is connected to the main contact assembly and the auxiliary contact assembly, respectively, so as to drive and control the main contact assembly and the auxiliary contact assembly to perform operation state switching, respectively. Particularly, an installation frame 3 is provided, where the installation frame 3 covers the outside of the upper end portion of the shaft assy, the installation frame 3 is provided with, on a side vertical wall, a first installation structure configured to carry and limit the auxiliary contact assembly, and through a combination of the first installation structure and the shaft assy, the auxiliary contact assembly can be formed into a normally-closed auxiliary contact assembly. Compared with existing HV DC contactor products with an auxiliary contact, the present disclosure can well realize, by means of a structure of the installation frame, installation of the normally-closed auxiliary contact assembly, without increasing an installation space, thus expanding applicable fields and applicable operation scenarios of the HV DC contactor products.

A reason why the present embodiment can realize the above functions is mainly that the structure of the installation frame 3 is innovatively designed, and an arrangement mode of the auxiliary contact assembly on the installation frame 3 is optimally controlled.

In Embodiment 1, preferably, the installation frame 3 is in an inverted U shape, and is fixedly covered on the outside of the upper end portion of the shaft assy, and the installation frame 3 is provided with, respectively on the two side vertical walls, the first installation structure; and the auxiliary contact assembly can be selectively provided on any one of the two first installation structures.

Further description is made as follows. The auxiliary contact assembly includes an auxiliary stationary contact 20 and an auxiliary movable contact piece 21 which are vertically provided, where the auxiliary movable contact piece 21 is connected to the upper end portion of the shaft assy; each of the first installation structures is provided with a first stationary installation portion provided on an outer surface of the side vertical wall of the installation frame 3, and a first movable installation portion provided on the side vertical wall of the installation frame 3 and meanwhile located below the first stationary installation portion, where the first stationary installation portion is configured to install the auxiliary stationary contact 20, and the first movable installation portion is configured for the auxiliary movable contact piece 21 to extend out of the installation frame 3; and when the auxiliary contact assembly is provided on one of the first installation structures, a part of the auxiliary movable contact piece 21 extending out of the installation frame 3 is disposed below the auxiliary stationary contact 20, and the first movable installation portion can further abut against the auxiliary movable contact piece 21, and form a rotational fulcrum at an abutting place.

By describing relative connection relationship between the auxiliary contact assembly and the first installation structure and the shaft assy in the above, an operation mode of the auxiliary contact assembly according to Embodiment 1 is as follows: when the auxiliary contact assembly is provided on one of the first installation structures, the auxiliary movable contact piece 21 can be driven by the shaft assy to partially move upwards, and partially deflect downwards around the rotational fulcrum, so that the part of the auxiliary movable contact piece 21 extending out of the installation frame 3 is disconnected from the auxiliary stationary contact 20; or the auxiliary movable contact piece 21 can be driven by the shaft assy to partially move downwards, and partially deflect upwards around the rotational fulcrum to be reset, so that the part of the auxiliary movable contact piece 21 extending out of the installation frame 3 contacts and communicates with the auxiliary stationary contact 20; and in this case, the auxiliary contact assembly is formed into the normally-closed auxiliary contact assembly.

Below, key improved structures of the HV DC contactor in the present embodiment, such as the installation frame 3 and the auxiliary contact assembly, will be described in detail.

In Embodiment 1, the installation frame 3 is an innovatively newly added structure, and the installation frame 3 is made from an insulating material, with a bottom side being fixedly connected to an upper side of a pole plate 4 of the HV DC contactor, and an inner wall being not in contact with the upper end portion of the shaft assy. As it is made from the insulating material, the installation frame 3 can isolate the main contact assembly and the auxiliary contact assembly, thus realizing isolation between high and low voltage, and being simple and reliable.

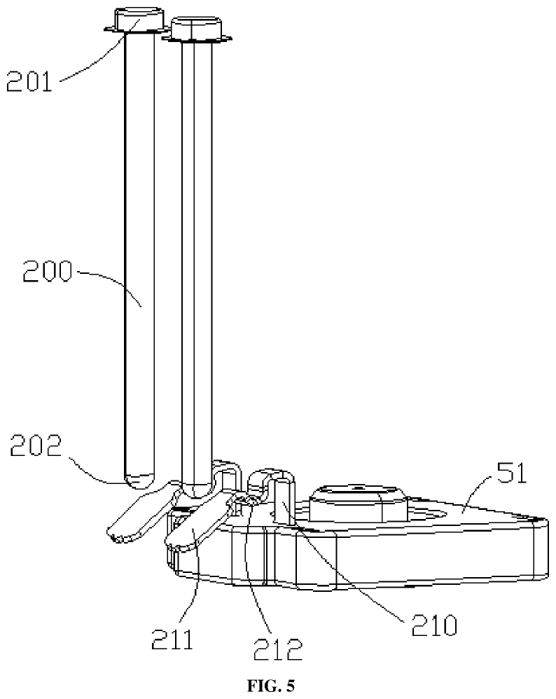

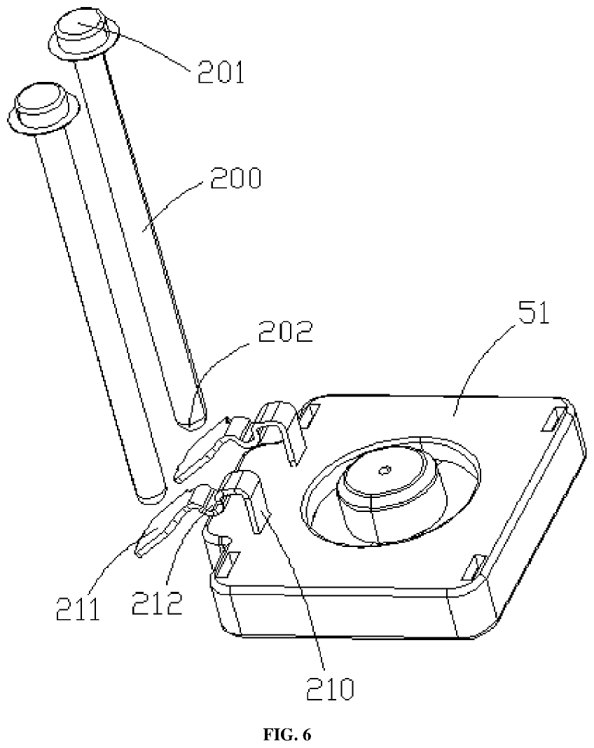

In addition, in order to fit the structure of the auxiliary stationary contact 20, specifically, the auxiliary stationary contact 20 includes a main body portion 200 in a cylindrical-rod shape, a head portion 201 provided on an upper end of the main body portion 200, and a stationary contacting portion 202 provided on a bottom end of the main body portion 200. Reference can be specifically made to FIG. 5 and FIG. 6.

The installation frame 3 is designed in structure as follows: the installation frame 3 is concavely provided with, respectively on outer surfaces of the two side vertical walls, a first receiving slot 30 extending in a vertical direction, where two first receiving slots 30 are both elongated arc-shaped slots matching the main body portion 200 in shape, and are both configured to insert and limit the auxiliary stationary contact 20, that is, the two first receiving slots 30 are both the first stationary installation portions. Reference can be made to FIG. 1 to FIG. 3.

The structure of the auxiliary stationary contact 20 is further supplementarily described as follows: the head portion 201 of the auxiliary stationary contact 20 is hermetically fixed on a ceramic chamber of the HV DC contactor. Particularly, the head portion 201 is electrically connected to a PCB provided on an outer wall of the ceramic chamber, and then is integrated to a coil group of the HV DC contactor through the PCB, thus implementing overall control over a low-voltage terminal.

In addition, in order to fit the structure of the auxiliary movable contact piece 21, specifically, the auxiliary movable contact piece 21 adopts an elastic sheet structure, and it is provided with a connecting portion 210 configured to be connected to the upper end portion of the shaft assy, a movable contacting portion 211 configured to operate in cooperation with the auxiliary stationary contact 20, and a joining portion 212 joined between the connecting portion 210 and the movable contacting portion 211, reference can be specifically made to FIG. 5 and FIG. 6.

The installation frame 3 is designed in structure as follows: the installation frame 3 is formed with, respectively on two side vertical walls, a first avoidance groove 31 having an opening on a bottom side of the two side vertical walls, where the two first avoidance grooves 31 are respectively correspondingly located below the two first receiving slots 30, that is, the two first avoidance grooves 31 are both in an inverted U shape, and are both the first movable installation portions, respectively configured for the auxiliary movable contact piece 21 to move therethrough; moreover, a top wall of each of the first avoidance grooves 31 can further abut against the auxiliary movable contact piece 21, and form a rotational fulcrum at an abutting place. Reference can be made to FIG. 1 to FIG. 3.

Further, the two first avoidance grooves 31 are respectively configured for the movable contacting portion 211 to move therethrough, and an end of the movable contacting portion 211 close to the joining portion 212 can abut against the top walls of the first avoidance grooves 31, and form the rotational fulcrum at the abutting place. Moreover, in order to facilitate deflection of the movable contacting portion 211, the top walls of the first avoidance grooves 31 are designed in a downward convex arc shape, and inner surfaces of the top walls of the first avoidance grooves 31 are formed with an avoidance recess for avoiding the joining portion 212.

The structure of the auxiliary movable contact piece 21 is supplementarily described as follows: the movable contacting portion 211 is a part that needs to deflect, and the movable contacting portion 211 is designed in a flat-sheet shape, so that a contact area thereof with the auxiliary stationary contact 20 can be increased. The joining portion 212 and the connecting portion 210 are parts that move up and down with the shaft assy, and particularly, the joining portion 212 is further designed in a curved shape, such as a wavy shape, so that it is easy to be deformed when the movable contacting portion 211 vertically deflects, vertical deflection of the movable contacting portion 211 will not be interfered with, and an elastic reset force is provided for upward deflection of the movable contacting portion 211.

Additional description is supplementarily made as follows: in the structure of the HV DC contactor provided in Embodiment 1, two auxiliary stationary contacts 20 and two auxiliary movable contact pieces 21 are provided; therefore, in Embodiment 1, the two side vertical walls of the installation frame 3 are each formed with two first receiving slots 30 and one first avoidance groove 31.

It can be seen from the above that, the way of installing and combining the installation frame 3 and the auxiliary contact assembly, on the basis of not increasing the installation space, further reduces assembly difficulty, improves assembly efficiency and assembly precision, and improves operation reliability of the HV DC contactor.

In Embodiment 1, the main contact assembly, the shaft assy and the yoke assy all use conventional structures in the technical field of HV DC contactors, and specific structures thereof are respectively described as follows.

The main contact assembly includes a main stationary contact 10 and a main movable contact piece 11 which are vertically provided, where the main movable contact piece 11 is connected to the upper end portion of the shaft assy, and the main movable contact piece 11 can be driven by the shaft assy to move upwards so as to contact and communicate with the main stationary contact 10, or move downwards so as to be disconnected from the main stationary contact 10.

The shaft assy includes a push rod 50, an insulating block 51, a limiting bracket 52 and a contact spring 53. A lower end of the push rod 50 is connected to a movable iron core of the HV DC contactor, and an upper end of the push rod 50 is fixedly provided with the insulating block 51. The limiting bracket 52 is vertically installed on the insulating block 51. A lower end of the contact spring 53 is fixedly provided in the insulating block 51 (specifically, the insulating block 51 is concavely provided with, on an upper side, an installation slot for positioning and inserting the lower end of the contact spring 53), an upper end of the contact spring 53 abuts against the main movable contact piece 11, so as to abut the main movable contact piece 11 on an inner top wall of the limiting bracket 52. In addition, an end of the auxiliary movable contact piece 21 (specifically, an end of the connecting portion 210 facing back to the joining portion 212) is fixedly embedded in the insulating block 51 through an injection molding process. The upper end portion of the shaft assy includes the insulating block 51, the limiting bracket 52 and the contact spring 53.

In addition, the limiting bracket 52 is further described. The limiting bracket 52 may be of an inverted U-shaped basket structure or a quadrangular box structure. When the limiting bracket 52 is of the inverted U-shaped basket structure, a bottom side of the limiting bracket 52 is engaged with the insulating block 51 (which is general common technical means in the field of HV DC contactors). When the limiting bracket 52 is of the quadrangular box structure, the bottom side of the limiting bracket 52 is embedded into the insulating block 51 through the injection molding process.

The yoke assy includes an upper yoke 60 and a lower yoke 61, where the upper yoke 60 is fixedly provided on an inner top wall of the installation frame 3, and the lower yoke 61 is provided between the main movable contact piece 11 and the contact spring 53. On the one hand, when the main movable contact piece 11 and the main stationary contact 10 attract and communicate with each other, the lower yoke 61 and the upper yoke 60 can form a magnetic loop therebetween, so as to realize generation of an electromagnetic force with an upward force direction for the main movable contact piece 11, so that the main movable contact piece 11 and the main stationary contact 10 are more tightly attracted to each other; on the other hand, the upper yoke 60 is installed on the installation frame 3, so that the size of the HV DC contactor can be well reduced, thus further expanding applicable scenarios of the HV DC contactor.

### Embodiment 2

Compared with the structure of the HV DC contactor provided in Embodiment 1, a structure of an HV DC contactor provided in Embodiment 2 is mainly different in that: a part of the installation frame 3 that fits the auxiliary movable contact piece 21 is altered. Other components and structures are the same as those in Embodiment 1. That is, the HV DC contactor provided in Embodiment 2 is also an HV DC contactor.

In Embodiment 2, in order to fit the structure of the auxiliary movable contact piece 21, the installation frame 3 is designed in structure as follows: the installation frame 3 is formed with, respectively on two side vertical walls, a first avoidance groove 31 having an opening on a bottom side of the two side vertical walls and a vertical edge side, and the two first avoidance grooves 31 are respectively correspondingly located below the two first receiving slots 30, that is, the two first avoidance grooves 31 are both in an inverted L shape, and are both the first movable installation portions, respectively configured for the auxiliary movable contact piece 21 to move therethrough; moreover, a top wall of each of the first avoidance grooves 31 in the inverted L shape can further abut against the auxiliary movable contact piece 21, and form a rotational fulcrum at an abutting place.

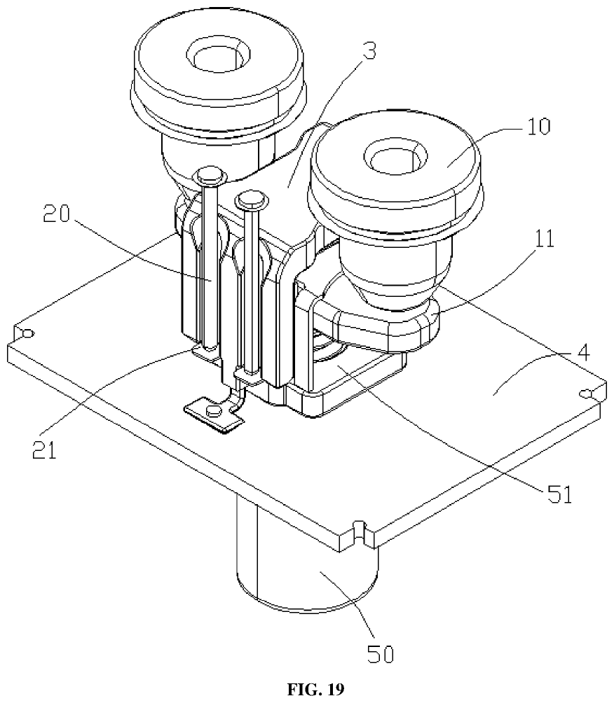

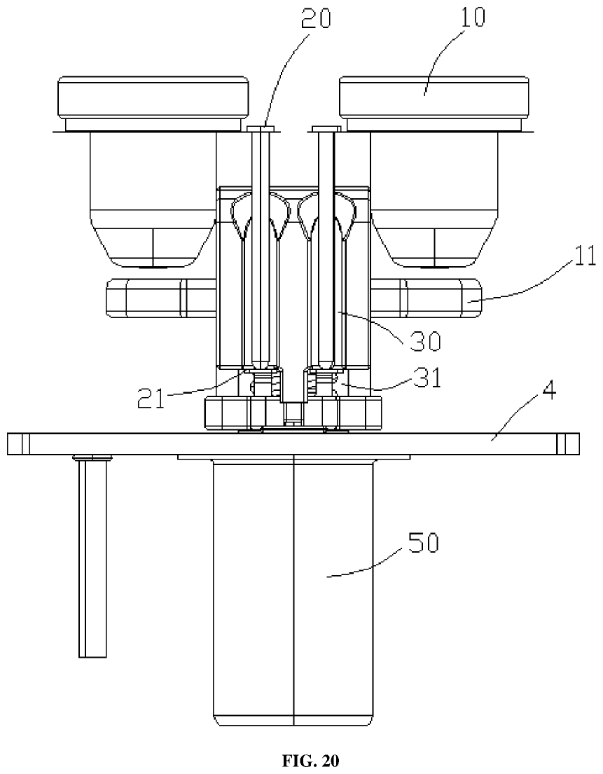

Further, in Embodiment 2, being the same as in Embodiment 1, the top wall of each of the first avoidance grooves 31 in the inverted L shape is in a downward convex arc shape, and an avoidance groove for avoiding the joining portion 212 is further formed on an inner surface of the top wall of the first avoidance groove 31. For the structure of the first avoidance grooves 31 in Embodiment 2, reference can be made to FIG. 19 and FIG. 20 in Embodiment 4.

Further, in the structure of the high-voltage direction current contactor provided in Embodiment 2, two auxiliary stationary contacts 20 and two auxiliary movable contact pieces 21 are provided; therefore, in Embodiment 2, the two side vertical walls of the installation frame 3 are each formed with two first receiving slots 30 and two first avoidance grooves 31, and the two first avoidance grooves 31 are further in mirror arrangement.

### Embodiment 3

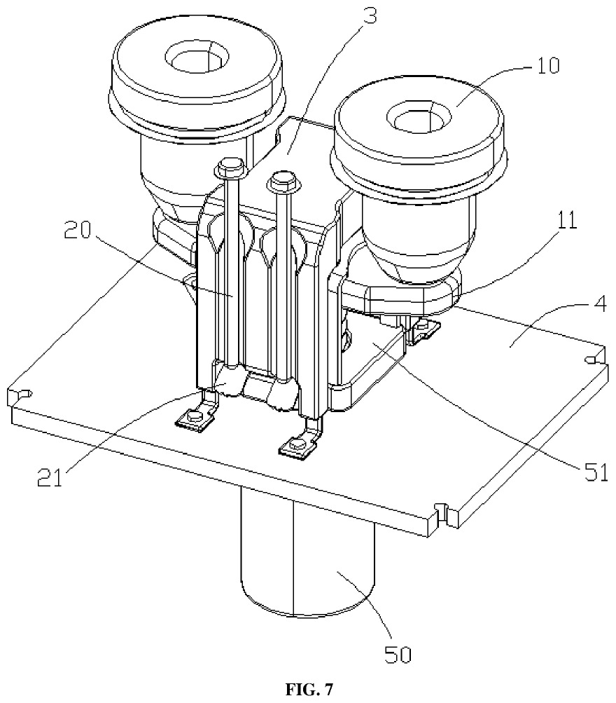

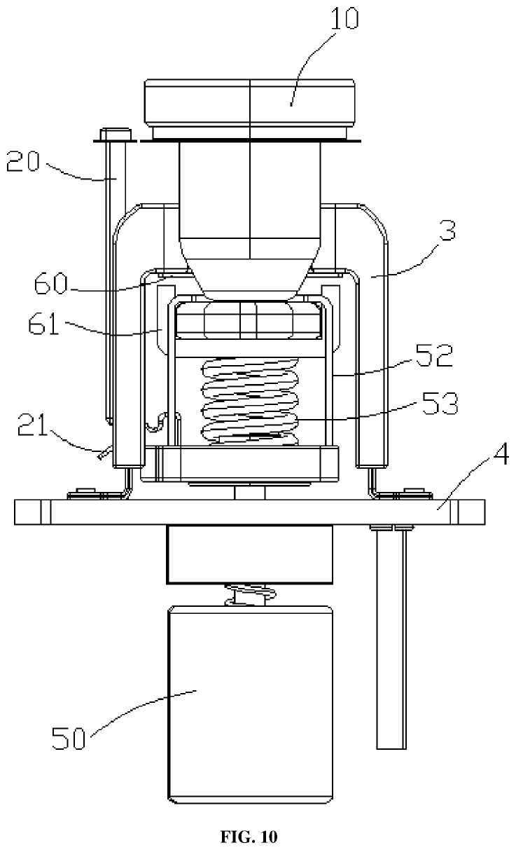

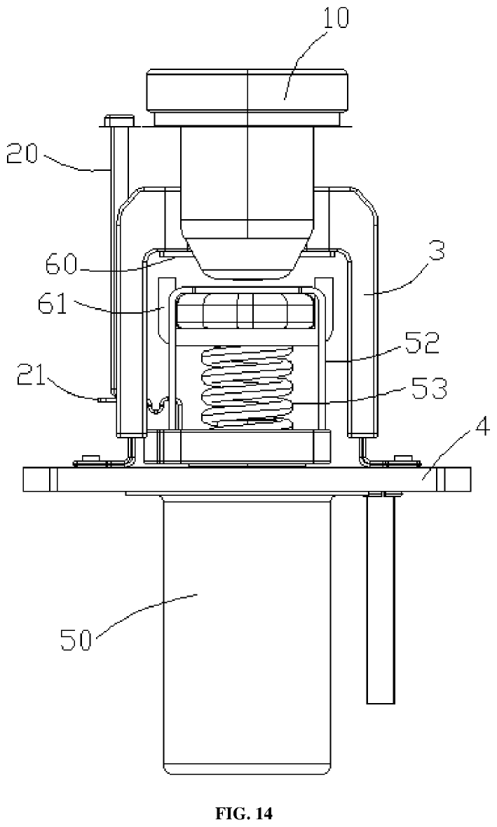

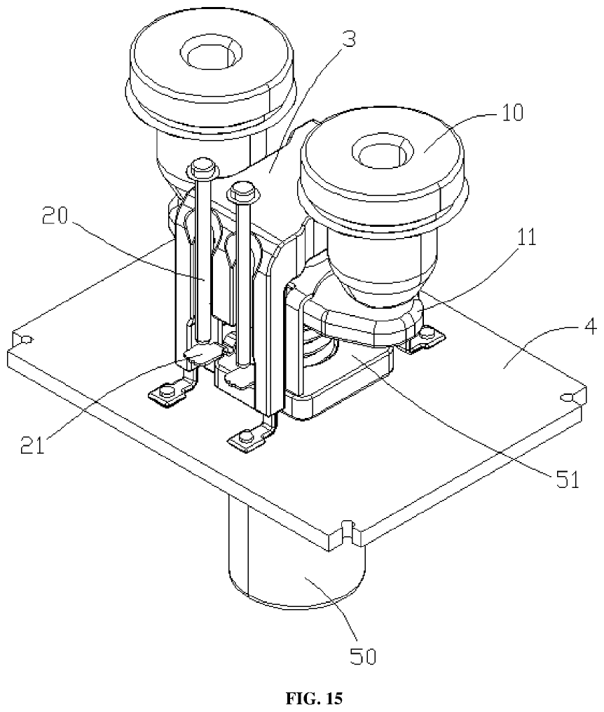

Compared with the structure of the HV DC contactor provided in Embodiment 1, a structure of an HV DC contactor provided in Embodiment 3 is mainly different in that: one first installation structure is provided on a first side vertical wall of the installation frame 3, and one second installation structure is provided on a second side vertical wall of the installation frame 3; and the auxiliary contact assembly can be selectively provided on the first installation structure or the second installation structure, where when the auxiliary contact assembly is provided on the first installation structure, the auxiliary contact assembly is formed into the normally-closed auxiliary contact assembly (reference can be specifically made to FIG. 7 to FIG. 14); and when the auxiliary contact assembly is provided on the second installation structure, the auxiliary contact assembly is formed into the normally-open auxiliary contact assembly (reference can be specifically made to FIG. 15 to FIG. 18). That is, the HV DC contactor according to Embodiment 3 is compatible with the normally-closed auxiliary contact assembly form and the normally-open auxiliary contact assembly form.

Therefore, compared with Embodiment 1, the structure of the HV DC contactor provided in Embodiment 3, on the basis of possessing the advantages of the structure of the HV DC contactor provided in Embodiment 1, is also compatible with the normally-closed auxiliary contact assembly form and the normally-open auxiliary contact assembly form, thus well expanding universality and applicability of application of the HV DC contactor, and thereby meeting use requirements for the HV DC contactor in different operation scenarios.

In Embodiment 3, preferably, the auxiliary contact assembly includes an auxiliary stationary contact 20 and an auxiliary movable contact piece 21 that are vertically provided, where the auxiliary movable contact piece 21 is connected to the upper end portion of the shaft assy.

The first installation structure includes a first stationary installation portion provided on an outer surface of the first side vertical wall of the installation frame 3, and a first movable installation portion provided on the first side vertical wall of the installation frame 3 and meanwhile located below the first stationary installation portion, where the first stationary installation portion is configured to install the auxiliary stationary contact 20, and the first movable installation portion is configured for the auxiliary movable contact piece 21 to extend out of the installation frame 3; and when the auxiliary contact assembly is provided on the first installation structure, a part of the auxiliary movable contact piece 21 extending out of the installation frame 3 is disposed below the auxiliary stationary contact 20, and the first movable installation portion can abut against the auxiliary movable contact piece 21, and form a rotational fulcrum at an abutting place.

The second installation structure includes a second stationary installation portion provided on an outer surface of the second side vertical wall of the installation frame 3, and a second movable installation portion provided on the second side vertical wall of the installation frame 3 and meanwhile located below the second stationary installation portion, where the second stationary installation portion is configured to install the auxiliary stationary contact 20, and the second movable installation portion is configured for the auxiliary movable contact piece 21 to extend out of the installation frame 3; and when the auxiliary contact assembly is provided on the second installation structure, a part of the auxiliary movable contact piece 21 extending out of the installation frame 3 is disposed below the auxiliary stationary contact 20, and the second movable installation portion is always not in contact with the auxiliary movable contact piece 21.

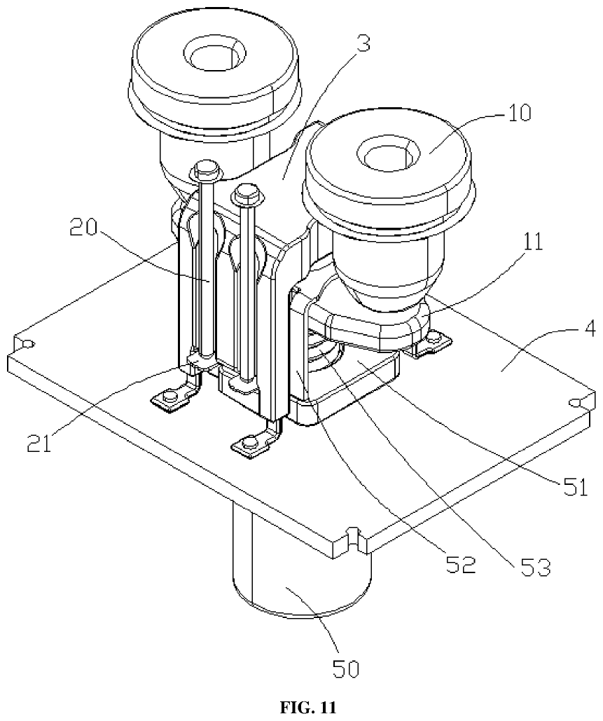

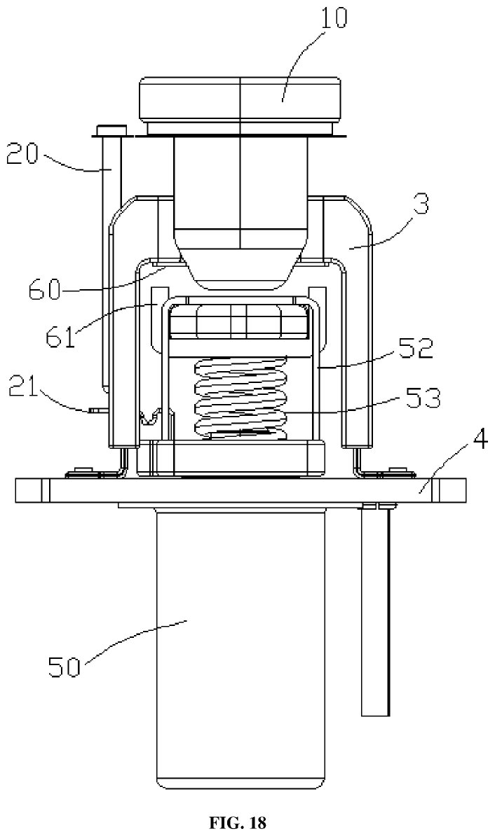

By describing relative connection relationship between the auxiliary contact assembly and the first installation structure, the second installation structure, and the shaft assy in the above, an operation mode of the auxiliary contact assembly in Embodiment 3 is as follows.
(1) When the auxiliary contact assembly is provided on the first installation structure, the auxiliary movable contact piece 21 can be driven by the shaft assy to partially move upwards, and partially deflect downwards around the rotational fulcrum, so that the part of the auxiliary movable contact piece 21 extending out of the installation frame 3 is disconnected from the auxiliary stationary contact 20 (reference can be made to FIG. 7 to FIG. 10 for a “disconnected” structure); or the auxiliary movable contact piece 21 can be driven by the shaft assy to partially move downwards, and partially deflect upwards around the rotational fulcrum to be reset, so that the part of the auxiliary movable contact piece 21 extending out of the installation frame 3 contacts and communicates with the auxiliary stationary contact 20 (reference can be made to FIG. 11 to FIG. 14 for a “contacting and communicating” structure); and in this case, the auxiliary contact assembly is formed into the normally-closed auxiliary contact assembly.
(2) When the auxiliary contact assembly is provided on the second installation structure, the auxiliary movable contact piece 21 can be driven by the shaft assy to move upwards, so as to contact and communicate with the auxiliary stationary contact 20, or move downwards so as to be disconnected from the auxiliary stationary contact 20 (reference can be made to FIG. 15 and FIG. 18 for a “disconnected” structure); and in this case, the auxiliary contact assembly is formed into the normally-open auxiliary contact assembly.

In addition, in a case where the auxiliary contact assembly is the normally-closed contact assembly, the above description for operation and drawings only illustrate that the auxiliary movable contact piece 21 realizes, by partially deflecting upwards or downwards around the rotational fulcrum, contact and communicating with or disconnection from the auxiliary stationary contact 20. However, in an actual application process, by altering the structure of the auxiliary movable contact piece 21, the auxiliary movable contact piece 21 can also realize, by partially flipping forwards or backwards, flipping to the left or right, or other modes, contact and communicating with or disconnection from the auxiliary stationary contact 20. Therefore, based on the solution “the auxiliary movable contact piece 21 partially deflecting upwards or downwards around the rotational fulcrum” described in detail in the present patent, “the auxiliary movable contact piece 21 partially flipping forwards or backwards, flipping to the left or right, or other modes” should also be covered within the scope of protection of the present patent.

Below, key improved structures of the HV DC contactor in Embodiment 3, such as the installation frame 3 and the auxiliary contact assembly, will be described in detail.

In Embodiment 3, the installation frame 3 is an innovatively newly added structure, and the installation frame 3 is made from an insulating material, with a bottom side being fixedly connected to an upper side of a pole plate 4 of the HV DC contactor, and an inner wall being not in contact with the upper end portion of the shaft assy. As it is made from the insulating material, the installation frame 3 can isolate the main contact assembly and the auxiliary contact assembly, thus realizing isolation between high and low voltage, and being simple and reliable.

In addition, in order to fit the structure of the auxiliary stationary contact 20, specifically, the auxiliary stationary contact 20 is provided with a main body portion 200 in a cylindrical-rod shape, a head portion 201 provided on an upper end of the main body portion 200, and a stationary contacting portion 202 provided on a bottom end of the main body portion 200. Reference can be specifically made to FIG. 5 and FIG. 6.

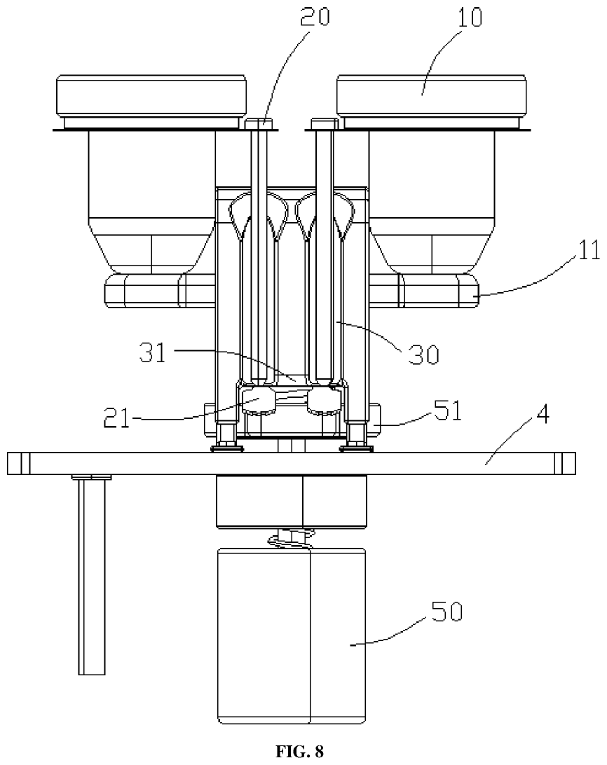

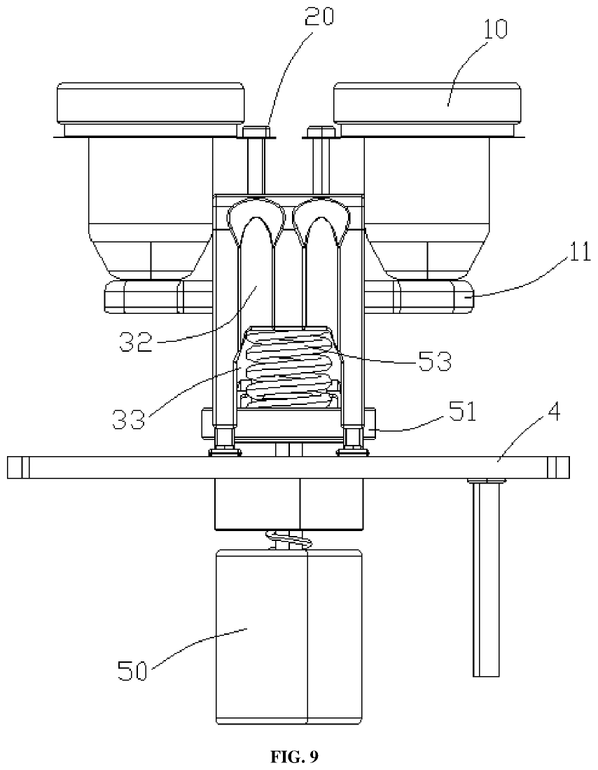

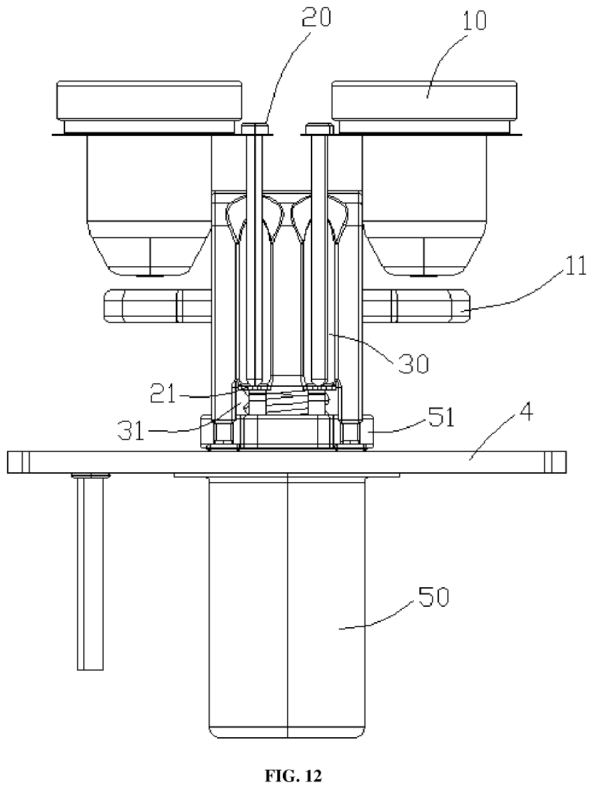

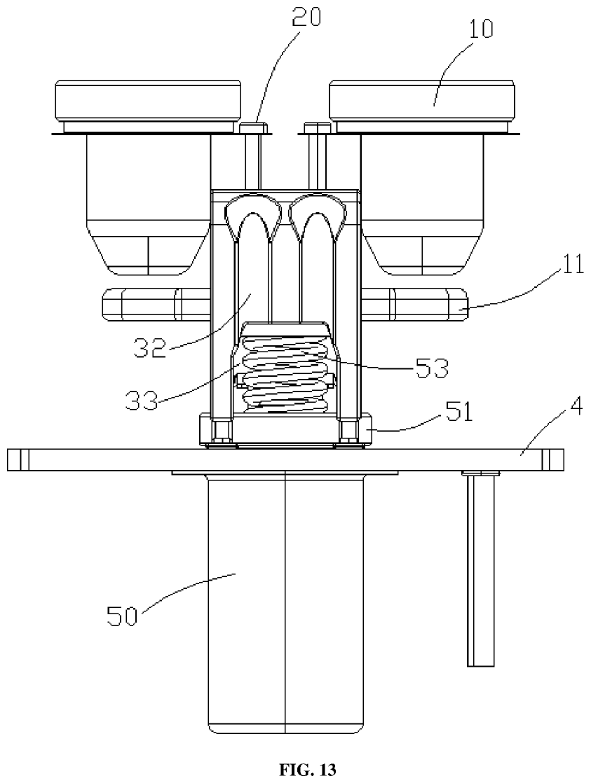

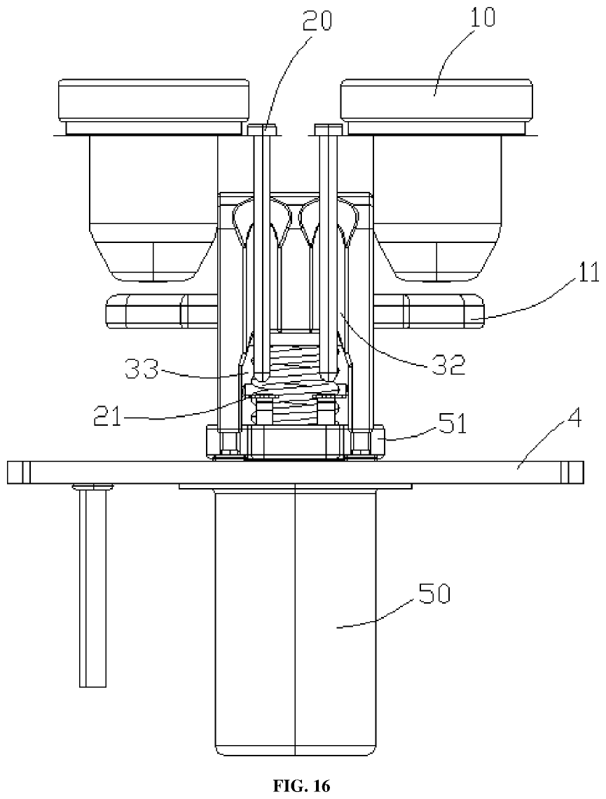

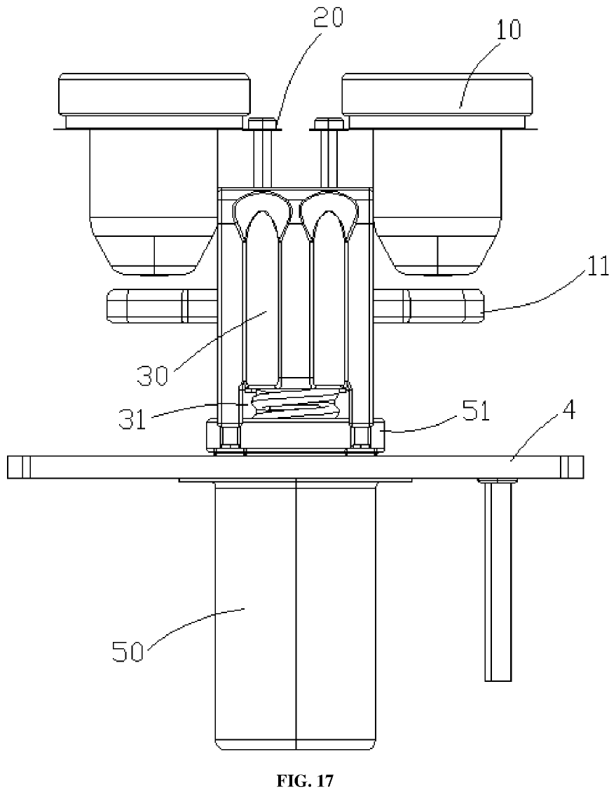

The installation frame 3 is designed in structure as follows: the installation frame 3 is concavely provided with, on the outer surface of the first side vertical wall, a first receiving slot 30 extending in a vertical direction, where the first receiving slot 30 is an elongated arc-shaped slots matching the main body portion 200 in shape (reference can be made to FIG. 8, FIG. 12 and FIG. 17), and the first receiving slot 30 is just the first stationary installation portion, configured to insert the auxiliary stationary contact 20; and the installation frame 3 is further concavely provided with, on the outer surface of the second side vertical wall, a second receiving slot 32 extending in the vertical direction (reference can be made to FIG. 9, FIG. 13 and FIG. 16), where the second receiving slot 32 is an elongated arc-shaped slot matching the main body portion 200 in shape, and the second receiving slot 32 is just the second stationary installation portion, configured to insert the auxiliary stationary contact 20.

Structures of the auxiliary stationary contact 20, the first receiving slot 30 and the second receiving slot 32 are further supplementarily described as follows: the head portion 201 of the auxiliary stationary contact 20 is hermetically fixed on a ceramic chamber of the HV DC contactor. Particularly, the head portion 201 is electrically connected to a PCB provided on an outer wall of the ceramic chamber, and then is integrated to a coil group of the HV DC contactor through the PCB, thus implementing overall control over a low-voltage terminal. A vertical height of the first receiving slot 30 is greater than that of the second receiving slot 32, mainly for fitting structures of the following first avoidance groove 31 and second avoidance groove 33.

In addition, in order to fit the structure of the auxiliary movable contact piece 21, specifically, the auxiliary movable contact piece 21 adopts an elastic sheet structure, and includes a connecting portion 210 configured to be connected to the upper end portion of the shaft assy, a movable contacting portion 211 configured to operate in cooperation with the auxiliary stationary contact 20, and a joining portion 212 joined between the connecting portion 210 and the movable contacting portion 211. Reference can be specifically made to FIG. 5 and FIG. 6.

The installation frame 3 is designed in structure as follows: the installation frame 3 is formed with, on the first side vertical wall, the first avoidance groove 31 having an opening on a bottom side of the first side vertical wall, where the first avoidance groove 31 is located below the first receiving slot 30, that is, the first avoidance groove 31 is in an inverted U shape, and is the first movable installation portion, configured for the auxiliary movable contact piece 21 to move therethrough (reference can be made to FIG. 8, FIG. 12 and FIG. 17); moreover, when the auxiliary contact assembly is provided on the first installation structure, a top wall of the first avoidance groove 31 can further abut against the auxiliary movable contact piece 21, and form a rotational fulcrum at an abutting place.

The installation frame 3 is further formed with, on the second side vertical wall, the second avoidance groove 33 having an opening on a bottom side of the second side vertical wall, where the second avoidance groove 33 is located below the second receiving slot 32, that is, the second avoidance groove 33 is of an inverted U shape, and is the second movable installation portion, configured for the auxiliary movable contact piece 21 to move therethrough; moreover, when the auxiliary contact assembly is provided on the second installation structure, the second avoidance groove 33 is always not in contact with the auxiliary movable contact piece 21 (it can be seen from FIG. 9, FIG. 13 and FIG. 16), which can be realized by designing a vertical height of the second avoidance groove 33 to be greater than that of the first avoidance groove 31.

A reason for such design is that: the second avoidance groove 33 does not need to be in contact with the auxiliary movable contact piece 21, and does not need to affect or interfere with movement of the auxiliary movable contact piece 21; while the first avoidance groove 31 needs to affect or interfere with the movement of the auxiliary movable contact piece 21, and needs to promote partial deflection of the auxiliary movable contact piece 21.

Further, structures of the first avoidance groove 31 and the auxiliary movable contact piece 21 are further supplementarily described as follows: I) the first avoidance groove 31 is configured for the movable contacting portion 211 to move therethrough, and an end of the movable contacting portion 211 close to the joining portion 212 can abut against the top wall of the first avoidance groove 31, and form the rotational fulcrum at the abutting place; moreover, in order to facilitate deflection of the movable contacting portion 211, the top wall of the first avoidance groove 31 is designed in a downward convex arc shape, and an inner surface of the top wall of the first avoidance groove 31 is formed with an avoidance recess for avoiding the joining portion 212. II) The movable contacting portion 211 is a part that needs to deflect, and the movable contacting portion 211 is designed in a flat-sheet shape, so that a contact area thereof with the auxiliary stationary contact 20 can be increased. The joining portion 212 and the connecting portion 210 are parts that move up and down with the shaft assy, and particularly, the joining portion 212 is further designed in a curved shape, such as a wavy shape, so that it is easy to be deformed when the movable contacting portion 211 vertically deflects, vertical deflection of the movable contacting portion 211 will not be interfered with, and an elastic reset force is provided for upward deflection of the movable contacting portion 211.

Additional description is supplementarily made as follows: in the structure of the HV DC contactor provided in Embodiment 3, two auxiliary stationary contacts 20 and two auxiliary movable contact pieces 21 are provided; therefore, in Embodiment 3, the first side vertical wall of the installation frame 3 is formed with two first receiving slots 30 and one first avoidance groove 31, and the second side vertical wall of the installation frame 3 is formed with two second receiving slots 32 and one second avoidance groove 33.

In addition, in Embodiment 1, the main contact assembly, the shaft assy and the yoke assy all use conventional structures in the technical field of HV DC contactors, and reference can be made to Embodiment 1 in the above for specific structures thereof.

### Embodiment 4

Compared with the structure of the HV DC contactor provided in Embodiment 3, a structure of an HV DC contactor provided in Embodiment 4 is mainly different in that: a part of the installation frame 3 that fits the auxiliary movable contact piece 21 is altered. Other components and structures are the same as those in Embodiment 3, that is, the HV DC contactor provided in Embodiment 4 is also a universal HV DC contactor compatible with the normally-closed auxiliary contact assembly form and the normally-open auxiliary contact assembly form.

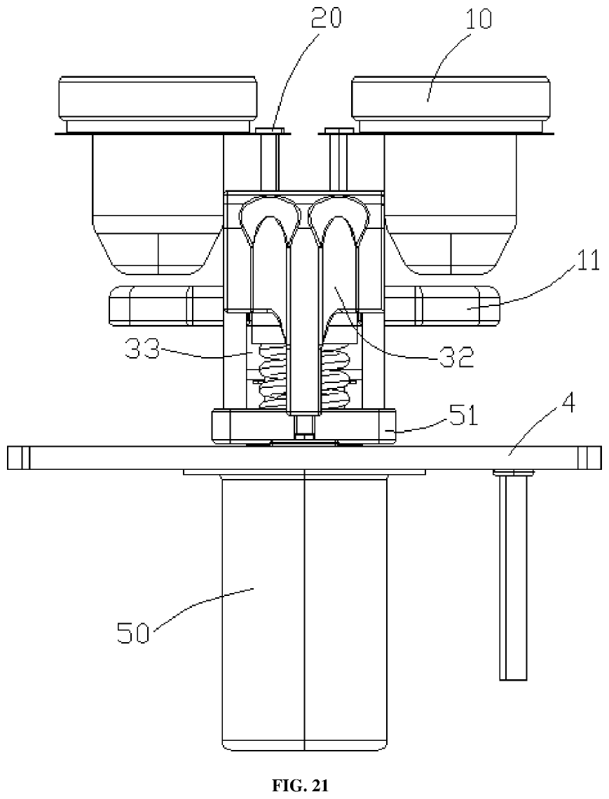

In Embodiment 4, in order to fit the structure of the auxiliary movable contact piece 21, the installation frame 3 is designed in structure as follows: with reference to FIG. 19 to FIG. 21, the installation frame 3 is formed with, on the first side vertical wall, the first avoidance groove 31 having an opening on the bottom side of the first side vertical wall and a vertical edge side, where the first avoidance groove 31 is located below the first receiving slot 30, that is, the first avoidance groove 31 is in an inverted U shape, and is the first movable installation portion, configured for the auxiliary movable contact piece 21 to move therethrough; moreover, when the auxiliary contact assembly is provided on the first installation structure, a top wall of the first avoidance groove 31 can further abut against the auxiliary movable contact piece 21, and form a rotational fulcrum at an abutting place.

The installation frame 3 is further formed with, on the second side vertical wall, the second avoidance groove 33 having an opening on the bottom side of the second side vertical wall and a vertical edge side, where the second avoidance groove 33 is located below the second receiving slot 32, that is, the second avoidance groove 33 is of an inverted U shape, and is the second movable installation portion, configured for the auxiliary movable contact piece 21 to move therethrough; moreover, when the auxiliary contact assembly is provided on the second installation structure, the second avoidance groove 33 is always not in contact with the auxiliary movable contact piece 21, which can be realized by designing the vertical height of the second avoidance groove 33 to be greater than that of the first avoidance groove 31 (a reason for such design can be seen in Embodiment 3).

Further, in Embodiment 4, being the same as in Embodiment 3, the top wall of each first avoidance groove 31 that is in the inverted L shape is in a downward convex arc shape, and an avoidance groove for avoiding the joining portion 212 is further formed on an inner surface of the top wall of the first avoidance groove 31.

Further, in the structure of the HV DC contactor provided in Embodiment 4, two auxiliary stationary contacts 20 and two auxiliary movable contact pieces 21 are provided; therefore, in Embodiment 4, the installation frame 3 is formed with, on the first side vertical wall, two first receiving slots 30 and two first avoidance grooves 31, and the two first avoidance grooves 31 are further in mirror arrangement. The installation frame 3 is also formed with, on the second side vertical wall, two second receiving slots 32 and two second avoidance grooves 33, and the two second avoidance grooves 33 are also in mirror arrangement.

To sum up, the HV DC contactor in the present disclosure has a novel and reasonable structure, a small size, controllability, and high universality and applicability, and can meet use requirements for HV DC contactors in different operation scenarios; besides, the HV DC contactor is also easy to process and install, thus improving assembly efficiency and assembly precision.

In the above description, many specific details are set forth in order to provide a thorough understanding of the present disclosure. However, the above description is only for preferred embodiments of the present disclosure, the present disclosure can be carried out in many other modes different from those described herein; therefore, the present disclosure is not limited to specific implementation disclosed above. Meanwhile, without departing from the scope of the technical solutions of the present disclosure, any skilled person familiar with the art might make many possible changes or modifications to the technical solutions in the present disclosure, or modify the same into equivalent examples with equivalent changes, in accordance with the method and technical contents disclosed in the above. Without departing from the contents of the technical solutions of the present disclosure, any simple alterations, equivalent changes, and modifications made to the above embodiments according to the technical essence of the present disclosure are still within the scope of protection of the technical solutions of the present disclosure.

1. A small-size HV DC contactor, comprising a main contact assembly, an auxiliary contact assembly and a shaft assy, wherein an upper end portion of the shaft assy is connected to the main contact assembly and the auxiliary contact assembly, respectively, so as to drive and control the main contact assembly and the auxiliary contact assembly to perform operation state switching, respectively, wherein an installation frame is provided, the installation frame covers an outside of the upper end portion of the shaft assy, and the installation frame is provided with, on a side vertical wall, a first installation structure configured to carry and limit the auxiliary contact assembly, wherein through a combination of the first installation structure and the shaft assy, the auxiliary contact assembly is capable of being formed into a normally-closed auxiliary contact assembly.

2. The small-size HV DC contactor according to claim 1, wherein the installation frame is in an inverted U shape, and fixedly covers the outside of the upper end portion of the shaft assy, and the installation frame is provided with the first installation structure on at least one of two side vertical walls.

3. The small-size HV DC contactor according to claim 2, wherein the installation frame is provided with, respectively on the two side vertical walls, the first installation structure;
and the auxiliary contact assembly is capable of being selectively provided on any one of the two first installation structures.

4. The small-size HV DC contactor according to claim 3, wherein the auxiliary contact assembly comprises an auxiliary stationary contact and an auxiliary movable contact piece which are provided in stack, wherein the auxiliary movable contact piece is connected to the upper end portion of the shaft assy;
each of the first installation structures is provided with a first stationary installation portion provided on an outer surface of the side vertical wall of the installation frame, and a first movable installation portion provided on the side vertical wall of the installation frame and meanwhile located below the first stationary installation portion, wherein the first stationary installation portion is configured for installing the auxiliary stationary contact, and the first movable installation portion is configured for the auxiliary movable contact piece to extend out of the installation frame; and
when the auxiliary contact assembly is provided on one of the first installation structures, a part of the auxiliary movable contact piece extending out of the installation frame is disposed below the auxiliary stationary contact, and the first movable installation portion is further capable of abutting against the auxiliary movable contact piece, and forming a rotational fulcrum at an abutting place.

5. The small-size HV DC contactor according to claim 4, wherein when the auxiliary contact assembly is provided on one of the first installation structures, the auxiliary movable contact piece can be driven by the shaft assy to partially move upwards, and partially deflect downwards around the rotational fulcrum, so that the part of the auxiliary movable contact piece extending out of the installation frame is disconnected from the auxiliary stationary contact; or
the auxiliary movable contact piece can be driven by the shaft assy to partially move downwards, and partially deflect upwards around the rotational fulcrum to be reset, so that the part of the auxiliary movable contact piece extending out of the installation frame contacts and communicates with the auxiliary stationary contact; and in this case, the auxiliary contact assembly is formed into the normally-closed auxiliary contact assembly.

6. The small-size HV DC contactor according to claim 4, wherein the installation frame is concavely provided with, respectively on the outer surfaces of the two side vertical walls, a first receiving slot extending in a vertical direction, wherein the two first receiving slots are both the first stationary installation portions, and are both configured for inserting the auxiliary stationary contact.

7. The small-size HV DC contactor according to claim 6, wherein the auxiliary stationary contact comprises a main body portion in a cylindrical-rod shape, a head portion provided on an upper end of the main body portion, and a stationary contacting portion provided on a bottom end of the main body portion; and
the first receiving slots are elongated arc-shaped slots matching the main body portion in shape.

8. The small-size HV DC contactor according to claim 6, wherein the installation frame is formed with, respectively on the two side vertical walls, a first avoidance groove having an opening on a bottom side of the two side vertical walls, wherein the two first avoidance grooves are correspondingly located below the two first receiving slots respectively, and the two first avoidance grooves are both the first movable installation portions, respectively configured for the auxiliary movable contact piece to move therethrough; and a top wall of each of the first avoidance grooves is capable of further abutting against the auxiliary movable contact piece, and forming a rotational fulcrum at an abutting place.

9. The small-size HV DC contactor according to claim 6, wherein the installation frame is formed with, respectively on the two side vertical walls, a first avoidance groove having an opening on a bottom side of the two side vertical walls and a vertical edge side, the two first avoidance grooves are correspondingly located below the two first receiving slots respectively, and the two first avoidance grooves are both the first movable installation portions, respectively configured for the auxiliary movable contact piece to move therethrough; and a top wall of each of the first avoidance grooves is capable of further abutting against the auxiliary movable contact piece, and forming a rotational fulcrum at an abutting place.

10. The small-size HV DC contactor according to claim 8, wherein the auxiliary movable contact piece is of an elastic sheet structure, and is provided with a connecting portion configured to be connected to the upper end portion of the shaft assy, a movable contacting portion configured to operate in cooperation with the auxiliary stationary contact, and a joining portion joined between the connecting portion and the movable contacting portion, wherein the movable contacting portion is in a flat-sheet shape, the movable contacting portion moves through the first avoidance groove, and an end of the movable contacting portion close to the joining portion is capable of abutting against the top wall of the first avoidance groove, and forming the rotational fulcrum at an abutting place.

11. The small-size HV DC contactor according to claim 2, wherein a first side vertical wall of the installation frame is provided with one first installation structure, and a second side vertical wall of the installation frame is provided with one second installation structure; and
the auxiliary contact assembly is capable of being selectively provided on the first installation structure or the second installation structure, wherein when the auxiliary contact assembly is provided on the first installation structure, the auxiliary contact assembly is formed into the normally-closed auxiliary contact assembly; and when the auxiliary contact assembly is provided on the second installation structure, the auxiliary contact assembly is formed into a normally-open auxiliary contact assembly.

12. The small-size HV DC contactor according to claim 11, wherein the auxiliary contact assembly comprises an auxiliary stationary contact and an auxiliary movable contact piece that are provided in stack, the auxiliary movable contact piece being connected to the upper end portion of the shaft assy;
the first installation structure comprises a first stationary installation portion provided on an outer surface of the first side vertical wall of the installation frame, and a first movable installation portion provided on the first side vertical wall of the installation frame and meanwhile located below the first stationary installation portion, wherein the first stationary installation portion is configured for installing the auxiliary stationary contact, and the first movable installation portion is configured for the auxiliary movable contact piece to extend out of the installation frame; and
when the auxiliary contact assembly is provided on the first installation structure, a part of the auxiliary movable contact piece extending out of the installation frame is disposed below the auxiliary stationary contact, and the first movable installation portion is capable of abutting against the auxiliary movable contact piece, and forming a rotational fulcrum at an abutting place;
the second installation structure comprises a second stationary installation portion provided on an outer surface of the second side vertical wall of the installation frame, and a second movable installation portion provided on the second side vertical wall of the installation frame and meanwhile located below the second stationary installation portion, wherein the second stationary installation portion is configured for installing the auxiliary stationary contact, and the second movable installation portion is configured for the auxiliary movable contact piece to extend out of the installation frame; and
when the auxiliary contact assembly is provided on the second installation structure, the part of the auxiliary movable contact piece extending out of the installation frame is disposed below the auxiliary stationary contact, and the second movable installation portion is always not in contact with the auxiliary movable contact piece.

13. The small-size HV DC contactor according to claim 12, wherein when the auxiliary contact assembly is provided on the first installation structure, the auxiliary movable contact piece is capable of being driven by the shaft assy to partially move upwards, and partially deflect downwards around the rotational fulcrum, so that the part of the auxiliary movable contact piece extending out of the installation frame is disconnected from the auxiliary stationary contact; or the auxiliary movable contact piece is capable of being driven by the shaft assy to partially move downwards, and partially deflect upwards around the rotational fulcrum to be reset, so that the part of the auxiliary movable contact piece extending out of the installation frame contacts and communicates with the auxiliary stationary contact; and in this case, the auxiliary contact assembly is formed into the normally-closed auxiliary contact assembly; and
when the auxiliary contact assembly is provided on the second installation structure, the auxiliary movable contact piece is capable of being driven by the shaft assy to move upwards so as to contact and communicate with the auxiliary stationary contact, or move downwards so as to be disconnected from the auxiliary stationary contact; and in this case, the auxiliary contact assembly is formed into the normally-open auxiliary contact assembly.

14. The small-size HV DC contactor according to claim 12, wherein the installation frame is concavely provided with, on the outer surface of the first side vertical wall, a first receiving slot extending in a vertical direction, wherein the first receiving slot is the first stationary installation portion, configured for inserting the auxiliary stationary contact; and
the installation frame is further concavely provided with, on the outer surface of the second side vertical wall, a second receiving slot extending in the vertical direction, wherein the second receiving slot is the second stationary installation portion, configured for inserting the auxiliary stationary contact;
and a vertical height of the first receiving slot is greater than that of the second receiving slot.

15. The small-size HV DC contactor according to claim 14, wherein the auxiliary stationary contact comprises a main body portion in a cylindrical-rod shape, a head portion provided on an upper end of the main body portion, and a stationary contacting portion provided on a bottom end of the main body portion; and
the first receiving slot and the second receiving slot are both elongated arc-shaped slots matching the main body portion in shape.

16. The small-size HV DC contactor according to claim 14, wherein the installation frame is formed with, on the first side vertical wall, the first avoidance groove having an opening on a bottom side of the first side vertical wall, wherein the first avoidance groove is located below the first receiving slot, and the first avoidance groove is the first movable installation portion, configured for the auxiliary movable contact piece to move therethrough; and when the auxiliary contact assembly is provided on the first installation structure, a top wall of the first avoidance groove is capable of further abutting against the auxiliary movable contact piece, and forming a rotational fulcrum at an abutting place; and
the installation frame is further formed with, on the second side vertical wall, a second avoidance groove having an opening on a bottom side of the second side vertical wall, wherein the second avoidance groove is located below the second receiving slot, and the second avoidance groove is the second movable installation portion, configured for the auxiliary movable contact piece to move therethrough; and when the auxiliary contact assembly is provided on the second installation structure, the second avoidance groove is always not in contact with the auxiliary movable contact piece; and a vertical height of the second avoidance groove is greater than that of the first avoidance groove.

17. The small-size HV DC contactor according to claim 14, wherein the installation frame is formed with, on the first side vertical wall, the first avoidance groove having an opening on a bottom side of the first side vertical wall and a vertical edge side, wherein the first avoidance groove is located below the first receiving slot, and the first avoidance groove is the first movable installation portion, configured for the auxiliary movable contact piece to move therethrough; and when the auxiliary contact assembly is provided on the first installation structure, a top wall of the first avoidance groove is capable of further abutting against the auxiliary movable contact piece, and forming a rotational fulcrum at an abutting place; and
the installation frame is further formed with, on the second side vertical wall, the second avoidance groove having an opening on a bottom side of the second side vertical wall and a vertical edge side, wherein the second avoidance groove is located below the second receiving slot, and the second avoidance groove is the second movable installation portion, configured for the auxiliary movable contact piece to move therethrough; and when the auxiliary contact assembly is provided on the second installation structure, the second avoidance groove is always not in contact with the auxiliary movable contact piece; and a vertical height of the second avoidance groove is greater than that of the first avoidance groove.

18. The small-size HV DC contactor according to claim 16, wherein the auxiliary movable contact piece is of an elastic sheet structure, and is provided with a connecting portion configured to be connected to the upper end portion of the shaft assy, a movable contacting portion configured to operate in cooperation with the auxiliary stationary contact, and a joining portion joined between the connecting portion and the movable contacting portion, wherein the movable contacting portion is in a flat-sheet shape, the movable contacting portion is capable of moving through the first avoidance groove or the second avoidance groove; and when the movable contacting portion moves through the first avoidance groove, an end of the movable contacting portion close to the joining portion abuts against a top wall of the first avoidance groove, and forms the rotational fulcrum at an abutting place.

19. The small-size HV DC contactor according to claim 2, wherein a bottom side of the installation frame is fixedly connected to an upper side of a pole plate of the HV DC contactor, and an inner wall of the installation frame is not in contact with the upper end portion of the shaft assy.

20. The small-size HV DC contactor according to claim 5, wherein the main contact assembly comprises a main stationary contact and a main movable contact piece which are provided in stack, wherein the main movable contact piece is connected to the upper end portion of the shaft assy, and the main movable contact piece is capable of being driven by the shaft assy to move upwards so as to contact and communicate with the main stationary contact, or move downwards so as to be disconnected from the main stationary contact.

21. The small-size HV DC contactor according to claim 20, wherein the shaft assy comprises a push rod, an insulating block, a limiting bracket and a contact spring, wherein a lower end of the push rod is connected to a movable iron core of the HV DC contactor, an upper end of the push rod is fixedly provided with the insulating block, the limiting bracket is vertically installed on the insulating block, a lower end of the contact spring is fixedly provided in the insulating block, an upper end of the contact spring abuts against the main movable contact piece, so as to abut the main movable contact piece against an inner top wall of the limiting bracket; and an end of the auxiliary movable contact piece is fixedly embedded in the insulating block.

22. The small-size HV DC contactor according to claim 21, further provided with a yoke assy, wherein the yoke assy comprises an upper yoke and a lower yoke, wherein the upper yoke is fixedly provided on an inner top wall of the installation frame, and the lower yoke is provided between the main movable contact piece and the contact spring.
